(19) United States
(12) Patent Application Publication
(10) Pub. No.: US 2026/0073441 A1
(43) Pub. Date: Mar. 12, 2026

(54) SEARCH DOCUMENT GENERATION SYSTEM AND METHOD

(71) Applicant: RentPackage Co., Ltd., Hsinchu County (TW)

(72) Inventor: CHING-JU HSIEH, Hsinchu County (TW)

(21) Appl. No.: 18/829,325

(22) Filed: Sep. 10, 2024

(51) Int. Cl. G06Q 30/0601; G06F 3/0482; G06F 40/186

(52) U.S. Cl. CPC G06Q 30/0641; G06F 3/0482; G06F 40/186

(57) ABSTRACT

In a search document generation system, a computing device provides an operation page for a search document creator to operate to generate a search document to different users or user groups, and the different users or user groups can use the search document to search a search data content stored in a storage space. The search document creator can mark a search component at a position of the search document, sets the search data content which the search component is allowed to search, and then assigns the search component to the user or user group. Accordingly, the search document generation system can make the search document creator without requiring understanding data structure architecture or programming languages easily establish the search document to the different users or user groups, thus reducing difficulty for generating the search document to the different users or user groups.

### TECHNICAL FIELD

The present disclosure relates to a search document generation system and method, and in particularly to, a search document generation system and method, each of which can easily establish the search document to different users or user groups, and specifically, the search document generation system and method is provided for the search document creator to set the position which the search component is located at the search document, to set the search data content of the search component which is allowed to search, and to set the user or user group whom the search component is assigned to.

### RELATED ART

To generate a search document, such as a search page based on a Hypertext Markup Language (HTML), it is usually necessary for the search document creator to have a certain degree of understanding of the database architecture and the programming language to use the programming language to write codes of the search document for the user needs. However, not every search document creator has a certain degree of understanding of the database architecture and the programming language, and even if the search document creator has a certain degree of understanding of the database architecture and the programming language, it still needs programming to generate the search document. Thus, the conventional manner of generating the search document is inconvenient for the search document creator.

The conventional manner of generating the search document cannot assign the search document to a specific user and cannot restrict the contents which are allowed to be viewed by different users (i.e., the data contents of the table, which are displayed to the different users, cannot be defined), and further cannot restrict the operations of the data which are allowed to be operated by different users.

The current marketed free software, phpMyAdmin™, provides a service for the user to filter the searched data, but it still cannot define the allowed fields of the data in the same operation page which are displayed to the different users. F333urther, though JotForm™ and TypeForm™ provide services with table editing and displaying, each of them does not provide a service for the user to search the table.

### SUMMARY

To address the technical problems of the related art, the present disclosure provides a search document generation system. The search document generation system comprises a computing device. The computing device is used to communicate with a storage space, and is provided for a search document creator to operate to generate a search document to a first user or a first user group of multiple users for data search. Steps of generation of the search document, which are performed by the computing device, comprise: establishing an empty search document or a template search document as an editing search document; providing an operation page for the search document creator to operate, wherein the operation page is provided for the search document creator to select a search component from a component selection region of the operation page, and to mark the search component at a position of the editing search document in a document edit region of the operation page, and a search component set region of the operation page is provided for the search document creator to set a search data content which the search component is allowed to search, and to assign the search component to the first user or the first user group of the users; storing a setting information and the editing search document in the storage space, wherein the setting information comprises information which the search component of the editing search document is assigned to the first user or the first user group, the position which the search component is marked at the editing search document and the search data content of the search component; and generating, according to the setting information and the editing search document, the search document with the search component to the first user or the first user group of the users for data search.

To address the technical problems of the related art, the present disclosure also provides a search document generation method, the search document generation method is executed in a computing device, wherein the computing device is used to communicated with a storage space, and is provided for a search document creator to operate to generate a search document to a first user or a first user group of multiple users for data search, and the search document generation method comprises: establishing an empty search document or a template search document as an editing search document; providing an operation page for the search document creator to operate, wherein the operation page is provided for the search document creator to select a search component from a component selection region of the operation page, and to mark the search component at a position of the editing search document in a document edit region of the operation page, and a search component set region of the operation page is provided for the search document creator to set a search data content which the search component is allowed to search, and to assign the search component to the first user or the first user group of the users; storing a setting information and the editing search document in the storage space, wherein the setting information comprises information which the search component of the editing search document is assigned to the first user or the first user group, the position which the search component is marked at the editing search document and the search data content of the search component; and generating, according to the setting information and the editing search document, the search document with the search component to the first user or the first user group of the users for data search.

To sum up, the search document generation system and method provided by the present disclosure can be used by the search document creator to generate the search document to different users or user groups without requiring understanding data structure architecture or programming languages. Therefore, the development time for generating the search document to the different users or user groups can be reduced efficiently, and the development cost and difficulty for generating the search document to the different users or user groups can be also reduced.

### DESCRIPTIONS OF DRAWINGS

The accompanying drawings are included to provide a further understanding of the present disclosure and are incorporated in and constitute a part of this specification. The drawings illustrate exemplary embodiments of the present disclosure and, together with the descriptions, serve to explain the principles of the invention without limiting its scope. A brief description of the drawings is as follows:

FIG. 1 is a schematic block diagram of a search document generation system according to an embodiment of the present disclosure.

FIG. 2 is a schematic flow chart of a search document generation method according to an embodiment of the present disclosure.

FIG. 3 is a schematic diagram showing an operation page provided by a search document generation system or method according to an embodiment of the present disclosure.

FIG. 4 is another schematic diagram showing an operation page provided by a search document generation system or method according to an embodiment of the present disclosure.

FIG. 5A is another schematic diagram showing an operation page provided by a search document generation system or method according to an embodiment of the present disclosure.

FIG. 5B is another schematic diagram showing an operation page provided by a search document generation system or method according to an embodiment of the present disclosure.

FIG. 5C is another schematic diagram showing an operation page provided by a search document generation system or method according to an embodiment of the present disclosure.

FIG. 5D is another schematic diagram showing an operation page provided by a search document generation system or method according to an embodiment of the present disclosure.

FIG. 5E is another schematic diagram showing an operation page provided by a search document generation system or method according to an embodiment of the present disclosure.

FIG. 5F is another schematic diagram showing an operation page provided by a search document generation system or method according to an embodiment of the present disclosure.

FIG. 6 is another schematic diagram showing an operation page provided by a search document generation system or method according to an embodiment of the present disclosure.

FIG. 7 is a schematic diagram that a search document generated by a search document generation system or method according to an embodiment of the present disclosure displays a search result data.

FIG. 8 is another schematic diagram that a search document generated by a search document generation system or method according to an embodiment of the present disclosure displays a search result data.

### DETAILS OF EXEMPLARY EMBODIMENT

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

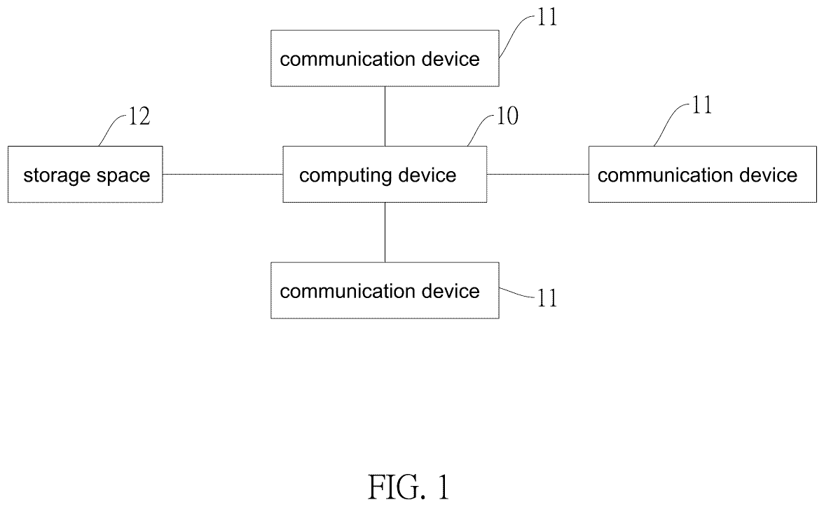

Refer to FIG. 1, and FIG. 1 is a schematic block diagram of a search document generation system according to an embodiment of the present disclosure. The search document generation system comprises a computing device 10, and the computing device 10 is used to communicate with multiple communication devices 11 of users, and communicate with a storage space 12. One of the users is a search document creator, other two of the users can be a first user in a first user group and a second user in a second user group. The storage space 12 is used to store an editing search document and corresponding setting information, such that the computing device 10 can obtain the editing search document and the corresponding setting information, both of which are stored in the storage space 12, and generate the search document to the different users or user groups for data search. Further, the search document creator operates the computing device 10 via the communication device 11, such that the computing device 10 can generate the search document to the different users or user groups, wherein a search component in the search document can be assigned to different users or different user group, and the search component has different filter conditions, different data display restrictions and different data operation restrictions for different user or different user groups.

It is noted that, though in the embodiment, there are three users and three communication devices 11, the present disclosure is not limited thereto. Further, different users may share one communication device 11. For example, the search document creator operates the computing device 10 via the communication device 11 to make the computing device generate the search document, and then the first user and the second user at different time operate the same communication device 11 to use the search document for data search. The search component of the search document can be assigned to the first user and the second user, and one of a filter condition, a data display restriction and a data operation restriction of the search component, which is corresponding to the second user, may not be the same as corresponding one of a filter condition, a data display restriction and a data operation restriction of the search component, which is corresponding to the first user.

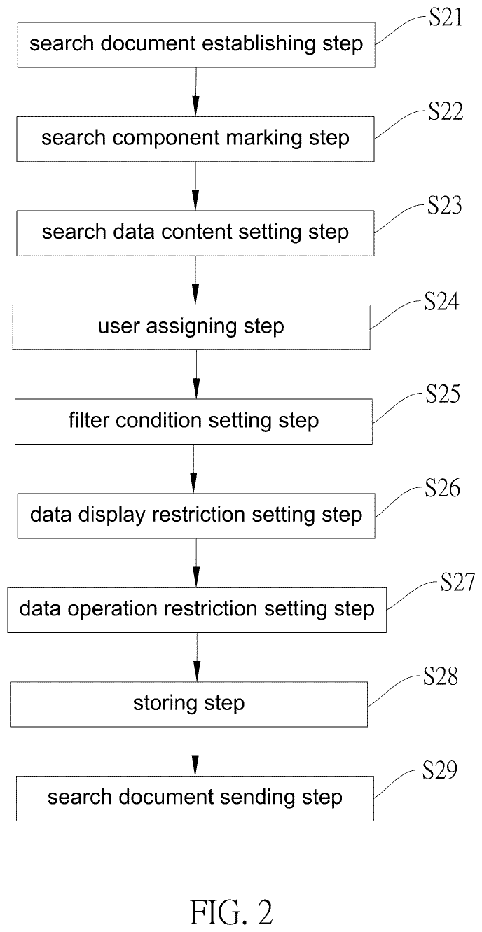

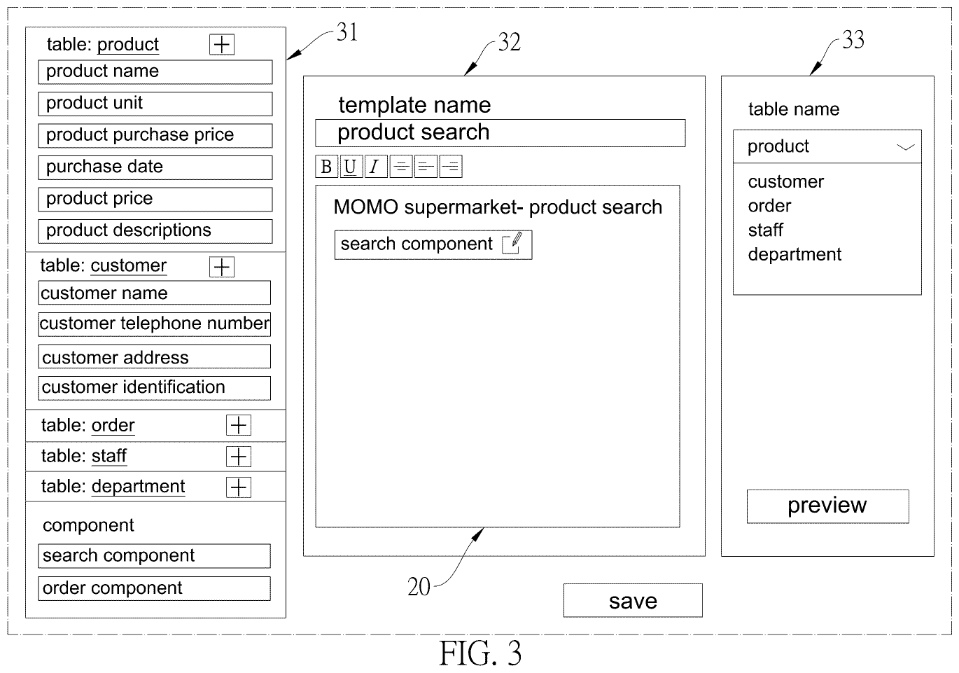

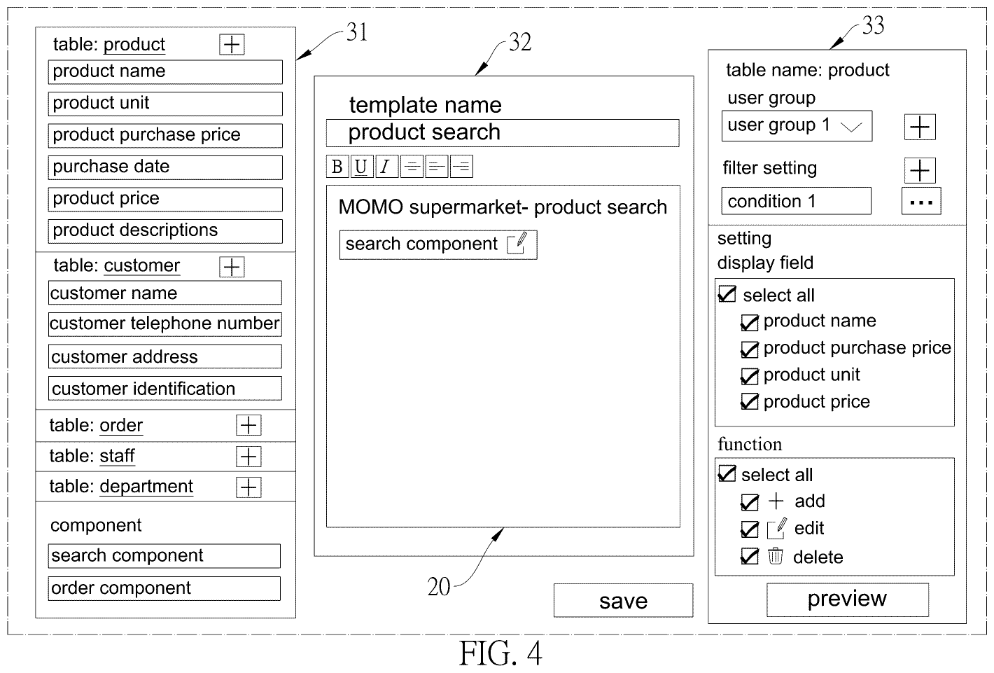

Refer to FIG. 1 to FIG. 4, FIG. 2 is a schematic flow chart of a search document generation method according to an embodiment of the present disclosure, FIG. 3 is a schematic diagram showing an operation page provided by a search document generation system or method according to an embodiment of the present disclosure, and FIG. 4 is another schematic diagram showing an operation page provided by a search document generation system or method according to an embodiment of the present disclosure. The search document generation system shown in FIG. 1 can execute the search document generation method shown in FIG. 2.

First, at a search document establishing step S21, the search document creator uses the communication device 11 to operate the computing device 10 to establish an empty search document or a template search document as an editing search document 20, and after the editing search document 20 is established, the computing device 10 provides an operation page for the search document creator. Simply speaking, at the search document establishing step S21, according to operation of the search document creator, the computing device 10 establishes the editing search document 20.

At a search component marking step S22, the search document creator selects a search component from a component selection region 31 in FIG. 3, and marks the selected the search component at one position (or multiple positions) of the editing search document 20. For example, the “component” field at the bottom of the component selection region 31 of the operation page has two components, “search component” and “order component”, which can be selected. The editing search document 20 is displayed in a document edit region 32 of the operation page shown in FIG. 3. On the other hand, the component selection region 31 has multiple table fields (such as, there are “customer name” and “customer telephone number” at the bottom of the “table: customer” field) to be selected, and the selected table field can be marked to one position (or multiple positions) of the editing search document 20.

When the communication device 11 used by the search document creator has a mouse, a touch pad or a trackball, for example, the communication device 11 is a notebook or a desktop computer, the search document creator drags the selected search component to located the selected search component at the position of the search document 20, so as to complete marking of the search component. When the communication device 11 used by the search document creator does not has a mouse, a touch pad and a trackball, but merely has touch control panel, for example, the communication device 11 is a pad or a smart phone, the search document creator firstly uses a finger or touch pen to touch the selected search component, and then touch the position of the editing search document 20, so as to complete marking of the search component. At the search component marking step S22, the search document creator can further edit texts of the editing search document 20 in the document edit region 32.

As shown in FIG. 3, the search document creator types “MOMO supermarket-product search” on the editing search document 20, selects the search component in the component selection region 31, and marks the selected search component at a position of the editing search document 20. In the example, the search component is marked at the position of the next line of “MOMO supermarket-product search”. Specifically, the search document creator can select more than one search component, and mark the more than one search component at more than one position of the editing search document 20. In short, at the search component marking step S22, the search document creator operates the computing device 10 to mark the selected search component at the position of the editing search document 20.

Next, at the search data content setting step S23, a search component set region 33 of the operation page is provided for the search document creator to set a search data content of the search component marked at the position of the editing search document 20, the search data content of the search component defines data which the search component is allowed to search. For example, set the search component to search one of “product” table data, “customer” table data, “order” table data, “staff” table data and “department” table data, setting the search data content which the search component which is allowed to search in the embodiment means selecting a table data which allowed to be searched, but the present disclosure is not limited thereto. In other embodiment, setting the search data content which the search component is allowed to search means selecting at least one of multiple document data or other data (such as, multiple sales reports for different products, or multiple different research reports) which is allowed to be searched.

After setting the search data content of the search component, the search document creator can click “preview” option at the bottom of the search component set region 33 to preview the search document, and then proceed to the next step. In short, at the search data content setting step S23, the search document creator operates the computing device 10 to set the search data content of the search component of the later generated search document, which the search component is allowed to search, but at this time, the setting information comprising the search data content which the search component is allowed to search is not stored. The setting information is stored until a storing step S28 is executed, and that is, the search data content setting step S23 is used to make the search document creator organize the search data content of the search component which the computing device 10 stores in the storage space 12.

Next, at the user assigning step S24, the search component set region 33 is further provided for the search document creator to assign the search component of the editing search document 20 to a user or a user group of the users. In addition, information of the users and the user groups can be input by the search document creator or generated by importing a table document with the information of the users and the user groups, and the present disclosure is not limited thereto.

The term “user groups” indicates that there are multiple users and each user group comprises at least one user. In one embodiment, when the search document creator assigns the search component of the editing search document 20 to a user group, this means the search document creator assigns the search component of the editing search document 20 to all users of the user group. Thus, in the present disclosure, the search component can be assigned to different user groups, and for the same search document, the display results of the search result data for the users in the different user groups may be different from each other, and the operations which allow the users in the different user groups to operate to the search result data may be different from each other.

In another embodiment, when the search document creator assigns the search component of the editing search document 20 to a user of a user group, this means the search component of the editing search document 20 is assigned to the user of the user group rather than all users of the user group, and for the same search document, the display results of the search result data for the users in the same user group may be different from each other, and the operations which allow the users in the same user group to operate to the search result data may be different from each other.

As shown in FIG. 4, the search component set region 33 of the operation page displays that “user group” is “user group 1”, and that is, the search document creator assigns the search component marked at the position of the editing search document 20 to all users of “user group 1”. Simply speaking, at the user assigning step S24, according to the operation of the search document creator, the computing device 10 assigns each the search component marked at one position of the editing search document 20 to one user or one user group, but at this time, the setting information comprising the information which the search component is assigned to the user or the user group is not stored. The setting information is stored until the storing step S28 is executed, and that is, the user assigning step S24 is used to make the search document creator organize the information which the search component is assigned to the user or the user group, and the computing device 10 will store the information which the search component is assigned to the user or the user group in the storage space 12 at the later step.

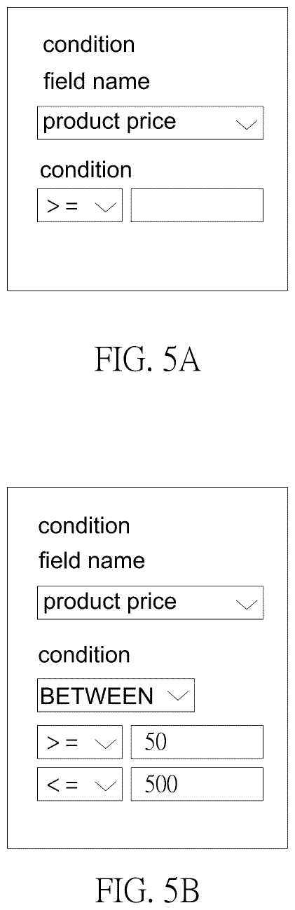

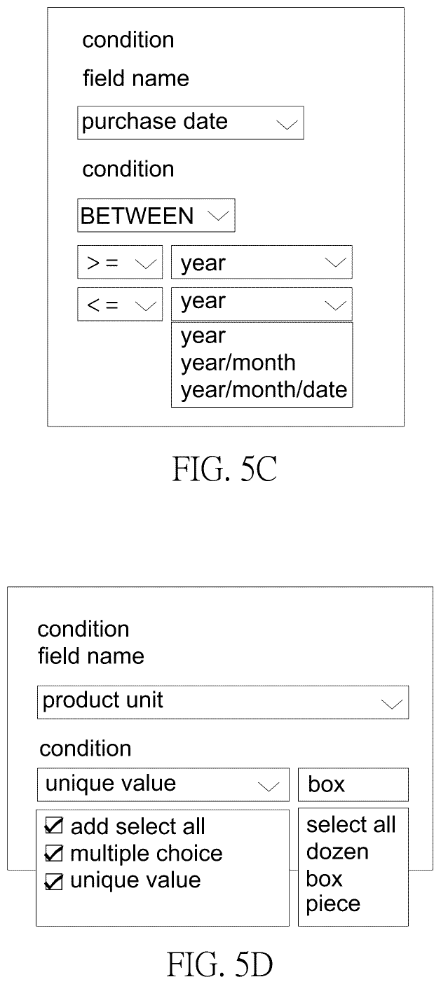

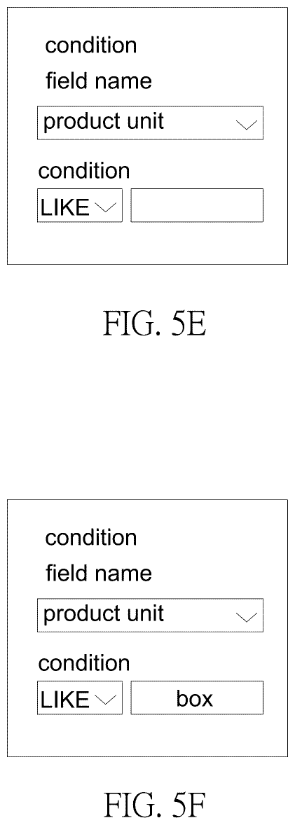

Next, at a filter condition setting step S25, the search component set region 33 of the operation page is provided for the search document creator to set at least one filter condition of the search data content of the search component, which is corresponding to the assigned user or user group. For example, the search document creator can click “+” option of “filter setting” in the search component set region 33 to add new filter condition of the search data content of the search component, which is corresponding to the assigned user or user group, and can click “. . . ” option near “condition 1” in search component set region 33 to set the filter condition. Then, one of operation pages in FIG. 5A to FIG. 5F is displayed, and details of setting the filter condition are described later. In short, at the filter condition setting step S25, according to the operation of the search document creator, the computing device 10 sets the at least one filter condition of the search data content of the search component marked at the position of the editing search document 20, which is corresponding to the assigned user or user group, but at this time, the setting information comprising the at least one filter condition of the search data content of the search component, which is corresponding to the assigned user or the user group, is not stored. The setting information is stored until the storing step S28 is executed, and that is, the filter condition setting step S25 is used to make the search document creator plan the at least one filter condition of the search data content of the search component, which is corresponding to the assigned user or the user group, and the computing device 10 will store the at least one filter condition of the search data content of the search component, which is corresponding to the assigned user or the user group, in the storage space 12 at the later step.

Specifically, since the search component can be assigned to different users or user groups, for the same search component, the filter conditions corresponding to different users or user groups may be different from each other. Thus, under some condition, the filter condition corresponding to one user or user group is set to allow numerical input, and the filter condition corresponding to another one user or user group is set to prohibit numerical input. Thus, when the search document is used by the other user or user group, he or she can only view the search result data but cannot input numerical for further search.

Refer to FIG. 5A to FIG. 5F, which show additional schematic diagrams of operation pages provided by a search document generation system or method according to an embodiment of the present disclosure. In FIG. 5A, the filter condition is set to filter “product price” in the search data content being a table data, the property of “product price” is a numerical, the formula of the filter condition is formed by a greater-than-or-equal-to operator (“>=”), the blank near the formula can be filled with a filter value, and the data type of the filter value is the numerical. If the filter value is not input by the search document creator, it means that when the search document is used, the assigned user or the user group can input the filter value. If the filter value is input by the search document creator, it means that when the search document is used, the filter condition with the input filter value directly acts as at least one part of a search condition. In some embodiment, once the filter value is input by the search document creator, when the search document displays the search result data, the filter condition and the filter value are prohibited to be displayed, thus the assigned user or user group cannot inspect the filter condition and the filter value, but merely can view the displayed search result data. The selection of the formula can be designed as a drop-down menu, and the formula can be one of a greater-than operator, a less-than operator, a greater-than-or-equal-to operator, a less-than-or-equal-to operator, an equal-to operator, a not-equal-to operator and a similar-to operator.

In FIG. 5B, the filter condition is set to filter “product price” in the search data content being a table data, the property of “product price” is a numerical, the formula of the filter condition is formed by a greater-than-or-equal-to operator (“>=”) and a less-than-or-equal-to operator (“<=”), the data type of the filter values is the numerical, and the two filter values are respectively input to be 50 and 500. In other words, in the embodiment, the filter condition that the product prices being 50 through 500 acts as at least one part of the search condition, and as mentioned above, when the search document displays the search result data, the filter condition and the filter values are not displayed, and the assigned user or user group merely can view the search result data.

In FIG. 5C, the filter condition is set to filter “purchase date” in the search data content being a table data, the property of “purchase date” is a date, the formula of the filter condition is formed by a greater-than-or-equal-to operator (“>=”) and a less-than-or-equal-to operator (“<=”). The data type of the filter values is the date. In the embodiment, the two filter values cannot be input by the search document creator, and only the assigned user or user group can input or define the duration of the purchase date for search when using the search document. In addition, the selection of the date type of the filter values can be designed as a drop-down menu, wherein one of “year”, “year/month” or “year/month/date” date type can be selected.

In FIG. 5D, the filter condition is set to filter “product unit” in the search data content being a table data, the property of “product unit” is a text (i.e., the data type of the filter value is the text), the formula of the filter condition is formed by an equal-to operator (“=”), as “unique value” option in FIG. 5D, and the text of the filter value is used to represents the unit, which can be “dozen”, “box” or “quantity”. In the embodiment, if the filter value is “box”, the filter condition which the product unit is box acts as at least one part of the search condition. In FIG. 5D, the formula can be selected to be “multiple choice”, the filter value can be selected to be “select all”, and the formula is formed by multiple equal-to operators and multiple logic-or operators, wherein the filter value being “select all” means that the filter condition which the product unit is dozen, box or quantity acts as at least one part of the search condition. In FIG. 5D, the formula can be selected to be “multiple choice”, the filter value can be selected to be “dozen” and “box”, and the formula is formed by multiple equal-to operators and one logic-or operator, wherein the filter value being “dozen” and “box” means that the filter condition which the product unit is dozen or box acts as at least one part of the search condition.

In FIG. 5E, the filter condition is set to filter “product unit” in the search data content being a table data, the property of “product unit” is a text (i.e., the data type of the filter value is the text), and the formula is formed by a similar-to operator (as “LIKE” shown in FIG. 5E). The filter value is not input by the search document creator, and the assigned user or the user group can input the filter value when using the search document. If the assigned user or the user group can input the filter value to be dozen in the search document, the filter condition that the product unit comprises “dozen” acts as the least part of the search condition, for example, the product unit being one dozen, two dozen, three dozen or multiple dozen acts as the least part of the search condition. In FIG. 5F, being different from FIG. 5E, the filter value is input to be “box” by the search document creator, and the filter condition that the product unit comprises “box” acts as the least part of the search condition, for example, the product unit being one box, two boxes, three boxes or multiple boxes acts as the least part of the search condition.

In short, the filter condition comprises at least a formula and at least a filter value. When a data type of the filter value is a date or a numerical, the formula is formed by at least one of a greater-than operator, a less-than operator, a greater-than-or-equal-to operator, a less-than-or-equal-to operator, an equal-to operator and a not-equal-to operator, and when the data type of the filter value is a text, the formula is one of an equal-to operator, a not-equal-to operator, and a similar-to operator. When the search component has multiple filter conditions, the filter conditions are linked via at least one of a logic-and operator, a logic-or operator or a logic-not operator.

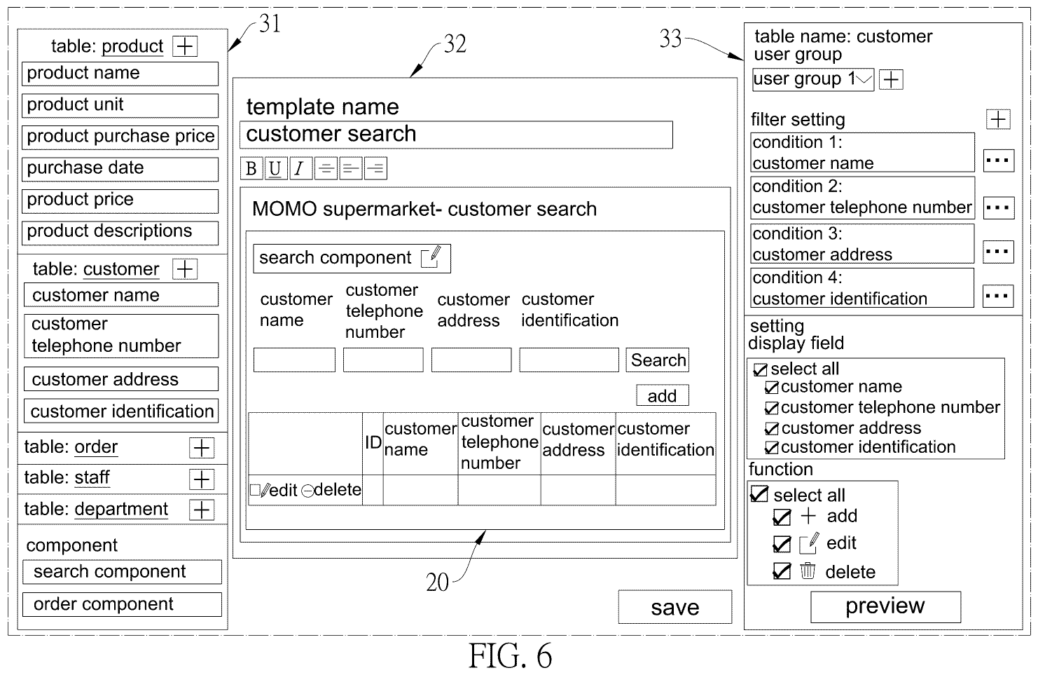

Next, refer to FIG. 1, FIG. 2 and FIG. 6, wherein FIG. 6 is another schematic diagram showing an operation page provided by a search document generation system or method according to an embodiment of the present disclosure. In FIG. 6, the search component is set to have multiple filter conditions, and the search document creator can link the filter conditions by at least one of a logic-and, a logic-or or a logic-not operators. For example, in FIG. 6, “condition 1: customer name”, “condition 2: customer telephone number”, “condition 3: customer address” and “condition 4: customer identification” are linked by using logic-and operators.

At a data display restriction setting step S26, the search component set region 33 is further provided for the search document creator to set a data display restriction, and the data display restriction which defines contents of the search result data are allowed to be displayed for the assigned user or user group. As shown in FIG. 4, in the display field, the search document creator can select the allowable display contents of the search result data. For example, “product name”, “product purchase price”, “product unit” and “product price” are selected to be displayed. If the search document creator does not want the search document to display the “product purchase price” of the search result data to the assigned user or user group, the search document creator can unclick the “product purchase price” in the display field of search component set region 33 (i.e., “product purchase price” is not selected). In short, at a data display restriction setting step S26, according to the operation of the search document creator, the computing device 10 sets the data display restriction of the search component marked at the position of the editing search document 20, corresponding to the assigned user or user group, and at this time, the setting information comprising the data display restriction of the search component marked at the position of the editing search document 20, corresponding to the assigned user or user group, is not stored. The setting information is stored until the storing step S28 is executed. That is, the data display restriction setting step S26 is used to make the search document creator organize the data display restriction of the search component marked at the position of the editing search document 20, corresponding to the assigned user or user group, and the computing device 10 will store the setting information in the storage space 12 at the storing step S28.

At a data operation restriction setting step S27, the search component set region 33 is further provided for the search document creator to set a data operation restriction of the search component, which the assigned user or user group is allowed to operate for the search result data. In FIG. 4, in the “function” field of the search component set region 33, the search document creator can select at least one of operations, which the assigned user or user group is allowed to operate for the search result data, for example, the operations can be “add”, “edit” and “delete”. If the search document creator wants to prohibit the user or user group from deleting at least a part of the search result data when the search document is used, the search document creator can unclick “delete” operation (i.e., the “delete” operation is not selected). In short, at the data operation restriction setting step S27, according to the operation of the search document creator, the computing device 10 sets the data operation restriction of the search component marked at the position of the search document 20, which the assigned user or user group is allowed to operate for the search result data, and at this time, the setting information comprising the data operation restriction of the search component marked at the position of the search document 20, which the assigned user or user group is allowed to operate for the search result data, is not stored. The setting information is stored until the storing step S28 is executed. That is, the data operation restriction setting step S27 is used to make the search document creator organize the data operation restriction of the search component marked at the position of the search document 20, which the assigned user or user group is allowed to operate for the search result data, and the computing device 10 will store the setting information in the storage space 12 at the storing step S28.

Further, after setting the data operation restriction, the search document creator can click “preview” option, and the editing search document 20 in the document edit region 32 can display the fields of “customer name”, “customer address” and “customer identification”, and a start-to-search option (i.e., “search” option in FIG. 6) and a table for displaying the search result data are arranged in the editing search document 20 in the document edit region 32, wherein the table of the search result data also displays the operations which the assigned user is allowed to operate, for example, “edit”, “delete”and “add”.

Next, at a storing step S28, the search document creator clicks the “save” option at the bottom of the document edit region 32, and the computing device 10 then stores the setting information and the editing search document 20 in the storage space 12, wherein the setting information comprises information which the search component of the editing search document 20 is assigned to the user or user group, the position which the search component is marked at the editing search document 20, and the search data content of the search component of the editing search document 20, and the data display restriction and the data operation restriction of the search component of the editing search document, which are corresponding to the first user and the first user group. By the way, before the storing step S28 is executed, there can be a step of setting a display piece number of the search result data which is allowed to be displayed on a single page, the computing device 10 provides the search component set region 33 for the search document creator to the display piece number of the search result data which is allowed to be displayed on the single page.

Last, at a search document sending step S29, the computing device 10, according to the setting information and the editing search document 20, generates the search document with the search component to the assigned user or user group for data search, wherein the search document is sent to the assigned user or user group via an email, a short message or a link generated by a third-party social communication network software, or the physical file of the search document is directly sent to the assigned user or user group.

Specifically, the search document can has the text content of the editing search document 20, the search data content of the search component of the search document is the same as the search data content of the search component which is marked at the position of the editing search document 20, the data display restriction of the search component of the search document, which is corresponding to the assigned user or user group, meets the data display restriction of the search component marked at the position of the editing search document 20, which is corresponding to the assigned user or user group, the data operation restriction of the search component of the search document, which is corresponding to the assigned user or user group, meets the data operation restriction of the search component marked at the position of the editing search document 20, which is corresponding to the assigned user or user group, and the position of the search document which the search component is located on is the same as or corresponding to the position which the search component is marked at the editing search document 20.

The search document creator can also assign the one search component of the editing search document 20 to multiple users or user groups, and set the filter condition, the data display restriction and each data operation restriction, which is corresponding to each one of the users or user groups. Then, according to the setting information and the editing search document 20, the computing device generates a search document to different users or user groups for data search. Since the setting information comprises the filter condition, the data display restriction and the data operation restriction of each assigned user or user group, the search result data displayed for different users or user groups using the same search document may be different (i.e., the data display restriction of the search component of the search document, which is corresponding to one user or user group, is not the same as the data display restriction of the search component of the search document, which is corresponding to another user or user group), and different users or user groups can perform different operations on search result data (i.e., the data operation restriction of the search component of the search document, which is corresponding to one user or user group, is not the same as the data operation restriction of the search component of the search document, which is corresponding to another user or user group).

The search document creator can regard the generated search document as a template, open the search document as the editing search document 20, re-mark the search component at another position of the editing search document 20, reset the search data content of the search component, and re-assign the search component to the user or user group, reset the filter condition of the search component corresponding to the assigned user or user group, reset the data display restriction of the search result data of the search component corresponding to the assigned user or user group, and/or reset the data operation restriction of the search result data of the search component corresponding to the assigned user or user group, so as to generate a new search document.

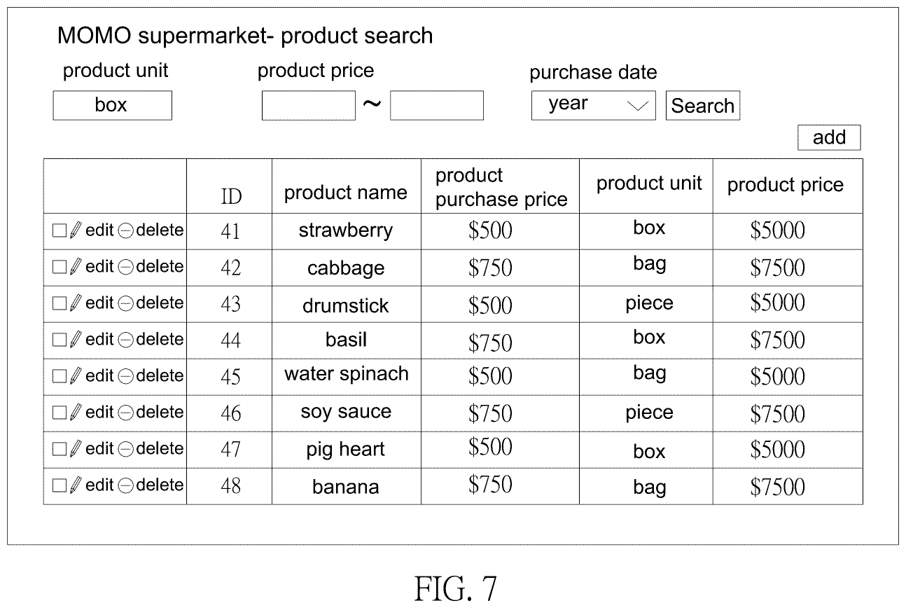

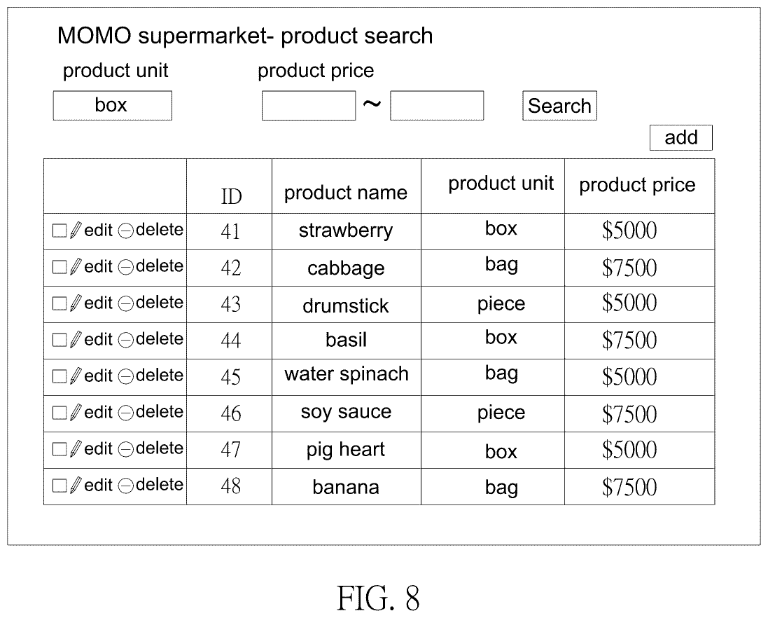

Refer to FIG. 7 and FIG. 8, FIG. 7 is a schematic diagram that a search document generated by a search document generation system or method according to an embodiment of the present disclosure displays a search result data, and FIG. 8 is another schematic diagram that a search document generated by a search document generation system or method according to an embodiment of the present disclosure displays a search result data. Specifically, FIG. 7 and FIG. 8 show different display results of the same search result data corresponding to the first user group and the second user group when using the same search document to obtain the same search result data. The data display restriction of the search component corresponding to the first user group is not the same as the data display restriction of the search component corresponding to the second user group, wherein the data display restriction of the search component corresponding to the second user group is configured to prohibit to display the product purchase price to the second user group, while the data display restriction of the search component corresponding to the first user group is configured to allow to display the product purchase price to the second user group. It is noted that, in another embodiment, FIG. 7 and FIG. 8 show different display results of the same search result data corresponding to the first user and the second user when using the same search document to obtain the same search result data, that is, the unit to assign the search component is not limited to be a user group, and the unit to assign the search component can be a user.

Still refer to FIG. 1 and FIG. 7. the search document is arranged with the start-to-search option, and after the start-to-search option is clicked by the a user of the first user group, the computing device 10 search the search data content stored in the storage space 12 to obtain a search result data, wherein the search result data is displayed by a table. When the search result data has duplicate contents, the computing device 10 makes the search document only display one of the duplicate contents. The search component of the search document is further provided for the user of the first user group to perform narrowing search, for example, performing the narrowing search on the displayed search result data with a narrowing range of the product price.

Further, in another condition, the search data content of the storage space 12 may be stored as data of two or more separated tables, and thus when the search component of the search document is used by the first user group to generate the search result data, the search result data is a multi-tables data (i.e., the data formed by multiple tables of the search data content), and at this time, the computing device 10 can join the multi-tables data, and displays the search result data by one table. For example, data of one table is a “product order” table which comprises information of “product order number”, “buyer” and “payment date”, data of another table is a “product order detail” table which comprises information of “product order number”, “product name” and “quantity”, thus the data of two tables are joined according to the same “product order number”, and then the data of the joined table is displayed in the search document by a single one table.

In another condition, the search data content of the storage space 12 may be stored as data of two or more separated tables, and thus when the search component of the search document is used by the first user group to generate the search result data, the search result data is a multi-tables data (i.e., the data formed by multiple tables of the search data content), and at this time, the computing device 10 can merge the multi-tables data, and displays the search result data by one table. For example, data of one table comprises information of “meat” and “vegetable” products, data of another table comprises information of “fruit” and “vegetable” products, thus the data of two tables are merged to data of a merged table which comprises information of “meat”, “vegetable” and “fruit” products, and then the data of the merged table is displayed in the search document by a single one table.

Still refer to FIG. 1, FIG. 2 and FIG. 6. By the way, when the search document creator operates the computing device 10 to generate the search document, and assigns the search component to at least two user groups, the above “preview” option can be designed to be a multi-user group search document preview option. When the multi-user group search document preview option is clicked by the search document creator, the computing device 10 generates a first preview search document corresponding to the first user group and a second preview search document corresponding to the second user group, such that the search document creator can preview the two preview search documents, and compare the differences between the two preview search documents, wherein the first preview search document can be displayed in the left half of the document edit region 32, and the second preview search document can be displayed in the right half of the document edit region 32.

It is noted that, still referring to FIG. 1, FIG. 2 and FIG. 3, in another embodiment, the filter condition, the data display restriction and the data operation restriction may not be set, and the search document without setting the filter condition, the data display restriction and the data operation restriction is generated to the user or user group. That is, the filter condition setting step S25 to the data operation restriction setting step S27 can be omitted, and the storing step S28 can be directly executed. In FIG. 3, after the search data content of the search component is set, and the search component is assigned to the user or user group, the search document creator can directly click the “save” option below document edit region 32. At this time, the filter condition, the data display restriction and the data operation restriction are not existed, and the setting information merely comprises the information which the search component of the editing search document 20 is assigned to the user or user group (for example, first user or first user group), the position of the editing search document 20 which the search component is marked at, and the search data content of the search component of the editing search document 20.

It is noted that, still refer to FIG. 1 to FIG. 4, in another embodiment, the data display restriction and the data operation restriction may not be set, and the search document without setting the data display restriction and the data operation restriction is generated to the user or user group. That is, the data display restriction setting step S26 and the data operation restriction setting step S27 are omitted, and the storing step S28 can be directly executed. In FIG. 3 and FIG. 4, after the search data content of the search component is set, the search component is assigned to the user or user group, and the filter condition corresponding to the user or user group is set, the search document creator can directly click the “save” option below document edit region 32. At this time, the data display restriction and the data operation restriction are not existed, and the setting information merely comprises the information which the search component of the editing search document 20 is assigned to the user or user group (for example, first user or first user group), the position of the editing search document 20 which the search component is marked at, the search data content of the search component of the editing search document 20, and the filter condition corresponding to the assigned user or user group.

To sum up, the search document generation system and method provided by the present disclosure can be operated and used by the search document creator without requiring understanding data structure architecture or programming languages, to easily establish the search document to the different users or user groups. The technical manner of the search document generation system and method provided by the present disclosure can let the search document creator to assign the search component of the search document to the user or user group, to mark the search component at the position of the search document, and to set the search data content which allows the search component to search. Thus, the same document or the different search documents can be generated to the different users or user groups, and the search components of the different search document can be allowed to search different search data contents. Simply put, compared with the related art, the search document generation system and method of the present disclosure can not only reduce the development time of the search document when generating different documents or the same search document to different users or user groups, but also can reduce the development cost and difficulty of generating the search document.

The foregoing summarizes the features of the embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

1. A search document generation system, comprising:
a computing device, used to communicate with a storage space, provided for a search document creator to operate to generate a search document to a first user or a first user group of multiple users for data search, wherein steps of generation of the search document, which are performed by the computing device, comprise:
establishing an empty search document or a template search document as an editing search document;
providing an operation page for the search document creator to operate, wherein the operation page is provided for the search document creator to select a search component from a component selection region of the operation page, and to mark the search component at a position of the editing search document in a document edit region of the operation page, and a search component set region of the operation page is provided for the search document creator to set a search data content which the search component is allowed to search, and to assign the search component to the first user or the first user group of the users;
storing a setting information and the editing search document in the storage space, wherein the setting information comprises information which the search component of the editing search document is assigned to the first user or the first user group, the position which the search component is marked at the editing search document and the search data content of the search component; and
generating, according to the setting information and the editing search document, the search document with the search component to the first user or the first user group of the users for data search.

2. The search document generation system of claim 1, wherein the search component set region is further provided for the search document creator to set a data display restriction of a search result data which is allowed to be displayed for the first user or the first user group, and to set a data operation restriction of the search result data which is allowed to be operated by the first user or the first user group, and the setting information further comprises the data display restriction and the data operation restriction of the search component of the editing search document, which are corresponding to the first user and the first user group.

3. The search document generation system of claim 2, wherein the search component set region is further provided for the search document creator to set at least a filter condition of the search data content of the search component, which is corresponding to the first user or the first user group, and the setting information further comprises the filter condition of the search component of the editing search component, which is corresponding to the first user or the first user group.

4. The search document generation system of claim 1, wherein the search component set region is further provided for the search document creator to set at least a filter condition of the search data content of the search component, which is corresponding to the first user or the first user group, and the setting information further comprises the filter condition of the search component of the editing search component, which is corresponding to the first user or the first user group.

5. The search document generation system of claim 3, wherein the computing device is further provided for the search document creator to operate to generate the search document to a second user or a second user group of the users, and one of a filter condition, a data display restriction and a data operation restriction of the search component of the search document, which is corresponding to the second user or the second user group, is not the same as corresponding one of a filter condition, a data display restriction and a data operation restriction of the search component of the search document, which is corresponding to the first user or the first user group.

6. The search document generation system of claim 1, wherein the operation page further has a multi-user group search document preview option, when the multi-user group search document preview option is click by the search document creator, the computing device generates a first preview search document corresponding to the first user group and a second preview search document corresponding to the second user group.

7. The search document generation system of claim 3, wherein the filter condition comprises at least a formula and at least a filter value, the formula is formed by at least one of a greater-than operator, a less-than operator, a greater-than-or-equal-to operator, a less-than-or-equal-to operator, an equal-to operator, a not-equal-to operator and a similar-to operator, and when the search component has multiple filter conditions, the filter conditions are linked via at least one of a logic-and operator, a logic-or operator or a logic-not operator.

8. The search document generation system of claim 1, wherein the position which the search component is marked at the editing search document is the same as or corresponding to a position which the search component is located at the search document.

9. The search document generation system of claim 1, wherein the search component of the search document is further provided for the first user or the first user group to perform narrowing search.

10. The search document generation system of claim 3, wherein the filter condition comprises at least one formula and at least one filter value, when a data type of the filter value is a date or a numerical, the formula is formed by at least one of a greater-than operator, a less-than operator, a greater-than-or-equal-to operator, a less-than-or-equal-to operator, an equal-to operator, a not-equal-to operator and a similar-to operator, and when the data type of the filter value is a text, the formula is one of an equal-to operator, a not-equal-to operator and a similar-to operator.

11. The search document generation system of claim 1, wherein after the first user or the first user group uses the search component of the search document to perform search, the computing device makes the search document displays a search result data, and the search result data is displayed by a table.

12. The search document generation system of claim 11, wherein when the search result data has duplicate contents, the computing device makes the search document only display one of the duplicate contents.

13. The search document generation system of claim 1, wherein after the first user or the first user group uses the search component of the search document to perform search, a search result data is generated, and when the search result data is a multi-tables data, at least one of a join process and a merge process is performed on the multi-tables data by the computing device, and the search result data is displayed in the search document by a table.

14. The search document generation system of claim 1, wherein the search document is allocated with a start-to-search option, when the start-to-search option is clicked by the first user or the first user group, the computing device searches the search data content stored in the storage space to obtain a search result data.

15. The search document generation system of claim 1, wherein the search component set region is further provided for the search document creator to set a display piece number of the search result data which is allowed to be displayed on a single page.

16. A search document generation method, executed in a computing device, wherein the computing device is used to communicated with a storage space, and is provided for a search document creator to operate to generate a search document to a first user or a first user group of multiple users for data search, and the search document generation method comprises:
establishing an empty search document or a template search document as an editing search document;
providing an operation page for the search document creator to operate, wherein the operation page is provided for the search document creator to select a search component from a component selection region of the operation page, and to mark the search component at a position of the editing search document in a document edit region of the operation page, and a search component set region of the operation page is provided for the search document creator to set a search data content which the search component is allowed to search, and to assign the search component to the first user or the first user group of the users;
storing a setting information and the editing search document in the storage space, wherein the setting information comprises information which the search component of the editing search document is assigned to the first user or the first user group, the position which the search component is marked at the editing search document and the search data content of the search component; and
generating, according to the setting information and the editing search document, the search document with the search component to the first user or the first user group of the users for data search.

17. The search document generation method of claim 16, wherein the search component set region is further provided for the search document creator to set a data display restriction of a search result data which is allowed to be displayed for the first user or the first user group, to set a data operation restriction of the search result data which is allowed to be operated by the first user or the first user group, and to set at least a filter condition of the search data content of the search component, which is corresponding to the first user or the first user group, and the setting information further comprises the data display restriction, the data operation restriction and the filter condition of the search component of the editing search document, which are corresponding to the first user or the first user group.

18. The search document generation method of claim 17, wherein the computing device is further provided for the search document creator to operate to generate the search document to a second user or a second user group of the users, and one of a filter condition, a data display restriction and a data operation restriction of the search component of the search document, which is corresponding to the second user or the second user group, is not the same as corresponding one of a filter condition, a data display restriction and a data operation restriction of the search component of the search document, which is corresponding to the first user or the first user group.

19. The search document generation method of claim 17, wherein the filter condition comprises at least a formula and at least a filter value, when a data type of the filter value is a date or a numerical, the formula is formed by at least one of a greater-than operator, a less-than operator, a greater-than-or-equal-to operator, a less-than-or-equal-to operator, an equal-to operator, a not-equal-to operator and a similar-to operator, and when the data type of the filter value is a text, the formula is one of an equal-to operator, a not-equal-to operator and a similar-to operator, wherein when the search component has multiple filter conditions, the filter conditions are linked via at least one of a logic-and operator, a logic-or operator or a logic-not operator.

20. The search document generation method of claim 16, wherein after the first user or the first user group uses the search component of the search document to perform search, the computing device makes the search document display a search result data, and the search component set region is provided for the search document creator to set the search result data to be displayed by a table; when the search result data has duplicate contents, the computing device makes the search document only display one of the duplicate contents; when the search result data is a multi-tables data, at least one of a join process and a merge process is performed on the multi-tables data by the computing device, and the search result data is displayed in the search document by the table; and the search component set region is further provided for the search document creator to set a display piece number of the search result data which is allowed to be displayed on a single page.
